(19) United States
(12) Patent Application Publication
(10) Pub. No.: US 2012/0221351 A1
(43) Pub. Date: Aug. 30, 2012

(54) METHOD AND SYSTEM FOR FACILITATING DATA ENTRY FOR AN INFORMATION SYSTEM

(75) Inventor: Puranjoy Bhattacharya, Bangalore (IN)

(73) Assignee: KONINKLIJKE PHILIPS ELECTRONICS N.V., EINDHOVEN (NL)

(21) Appl. No.: 13/501,757

(22) PCT Filed: Sep. 30, 2010
(86) PCT No.: PCT/IB10/54413

§ 371 Date: Apr. 13, 2012

(30) Foreign Application Priority Data
Oct. 14, 2009 (CN) 200910204735.5

(51) Int. Cl. G06F 17/30; G06Q 50/22

(52) U.S. Cl. 705/2; 707/723; 707/E17.082

(57) ABSTRACT

This invention presents a method and a system for facilitating data entry for an information system comprising a repository. According to the method, firstly, a first input of some first category parameters input by the user is received by means of a first user interface. Secondly, a first ranked list of a plurality of second category parameters is generated on the basis of the first input and the repository, and the first ranked list is displayed to the user by means of a second interface. Then a second input including some second category parameters selected by the user is received by means of the second user interface. Lastly, a second ranked list of a plurality of first category parameters is generated on the basis of the second input and the repository, and the second ranked list is displayed to the user by means of the first interface. In this way, the user can correctly determine the input data for the information system so as to get a more accurate output. And the user can get more information of various aspect observations (?) at any given penultimate stage as well as the final stage.

### FIELD OF THE INVENTION

The invention relates to a method and a system for facilitating data entry for an information system, in particular to a method and a system for facilitating data entry for a clinical decision support system comprising a repository.

### BACKGROUND OF THE INVENTION

Clinical decision support systems link health observations with health knowledge to influence health choices by clinicians for improved health care. Clinical decision support systems have the potential of substantially improving clinical decision-making and management of diseases. In addition, they provide standardization in diagnostics and treatment, and allow for rapid adoption of the latest know-how into clinical practice.

U.S. Pat. No. 7,552,104B2 provides a decision support method for two or more pre-defined criteria and two or more profiles. Each criterion comprises two or more pre-defined and ordinally ranked categories. Each profile comprises a set of two or more of the criteria. Each criterion in the set is associated with one of the categories for that criterion. The method performs a comparative assessment of profiles involving an ordinal pairwise ranking of profile pairs to obtain a point value for each category on each criterion and/or a ranking of all possible profiles and/or a ranking of a subset of all possible profiles.

### SUMMARY OF THE INVENTION

In existing information systems, such as a decision support system, a user can get an output result by inputting some data. The inventor of the present invention realized that a wrong input may generate a wrong output, and sometimes, a user does not know how to correct the input to get a correct output, even if he has modified the input data several times. Taking a clinical decision system as an example, a patient may get an output with respect to a medicine which has a negative effect if the patient, who has to input all the necessary symptoms, forgets to input an important symptom. And it is almost impossible for the patient to find out that he has forgotten to input the important symptom. In addition, physicians may analyze many clinical cases per day and it is also troublesome for them to do the data entry for the information system. The method presented in U.S. Pat. No. 7,552,104B2 cannot contribute to helping the user to select the input data.

In addition, the way in which a user gets information from the information system is inherently sequential. Taking the clinical decision support system as an example, the way a user addresses different aspects of a clinical episode—whether noting symptoms, performing symptomatic analyses or suggesting remedies—is inherently sequential. At any stage except the very final one, the information captured by the user is a partial snapshot of the total picture. The method presented in U.S. Pat. No. 7,552,104B2 cannot contribute to helping the user get information of various aspect observations at any given penultimate stage.

Based on understanding the current prior art and the data entry problem, it would be advantageous to enable the user of the information system to determine the input data correctly. It would also be desirable to enable the user of the information system to get information of various aspect observations at any given penultimate stage.

To better address one or more of the above concerns, according to an embodiment of a first aspect of the present invention, a method of facilitating data entry for an information system comprising a repository is proposed. The method comprises the steps of:

receiving a first input from a user by means of a first user interface, the first input including at least one first category parameter of an object of interest;

generating a first ranked list of a plurality of second category parameters of the object of interest on the basis of the first input and the repository;

displaying the first ranked list to the user by means of a second user interface;

receiving a second input from the user by means of the second user interface, the second input including at least one second category parameter of the object of interest, the at least one second category parameter being selected by the user from the first ranked list;

generating a second ranked list of a plurality of first category parameters of the object of interest on the basis of the second input and the repository; and

displaying the second ranked list to the user by means of the first user interface.

The basic idea of the method is to enable the user to determine the input by providing a ranked list of candidate input data according to the user's selection in a candidate output and the user can go back and forth through different categories of parameters. The method overcomes the prejudice that there is a clear line between the input and output data, and the user can only determine the input by himself/herself if the user wants a more accurate output. By receiving the second input selected by the user from the first ranked list and providing the second ranked list of the first category parameters on the basis of the second input, a valuable reference can be provided to help the user determine an input of the first category parameters. In this way, the user can correctly determine the input data for the information system so as to get a more accurate output. In addition, because the user can go back and forth through different categories of parameters, the user can go back and forth through multiple partial scenarios until he is satisfied with the overall consistency of the input and output. So the user can get more information of various aspect observations at any given penultimate stage as well as the final stage.

According to an embodiment of a second aspect of the present invention, a system for facilitating data entry for an information system comprising a repository is proposed. The system comprises:

a first user interface configured to receive a first input from a user, the first input including at least one first category parameter of an object of interest;

a processor configured to generate a first ranked list of a plurality of second category parameters of the object of interest on the basis of the first input and the repository; and

a second user interface configured to display the first ranked list to the user;

wherein

the second user interface is further configured to receive a second input from the user, the second input including at least one second category parameter of the object of interest, the at least one second category parameter being selected by the user from the first ranked list;

the processor is further configured to generate a second ranked list of a plurality of first category parameters of the object of interest on the basis of the second input and the repository; and

the first user interface is further configured to display the second ranked list to the user.

These and other aspects of the invention will be apparent from and elucidated with reference to the embodiments described hereinafter.

### DESCRIPTION OF THE DRAWINGS

The above and other objects and features of the present invention will become more apparent from the following detailed description considered in connection with the accompanying drawings, in which:

FIG. 1 (a) illustrates a schematic diagram of a flowchart of an embodiment of the method according to the present invention;

FIGS. 1 (b) to FIG. 1 (e) illustrate schematic diagrams of an embodiment of the first user interface and the second user interface;

FIG. 2 illustrates a schematic diagram of a flowchart of another embodiment of the method according to the present invention;

FIG. 3 illustrates a schematic diagram of a flowchart of a further embodiment of the method according to the present invention; and

FIG. 4 illustrates a schematic block diagram of an embodiment of the system according to the invention.

The same reference numerals are used to denote similar parts throughout the Figures.

### DETAILED DESCRIPTION

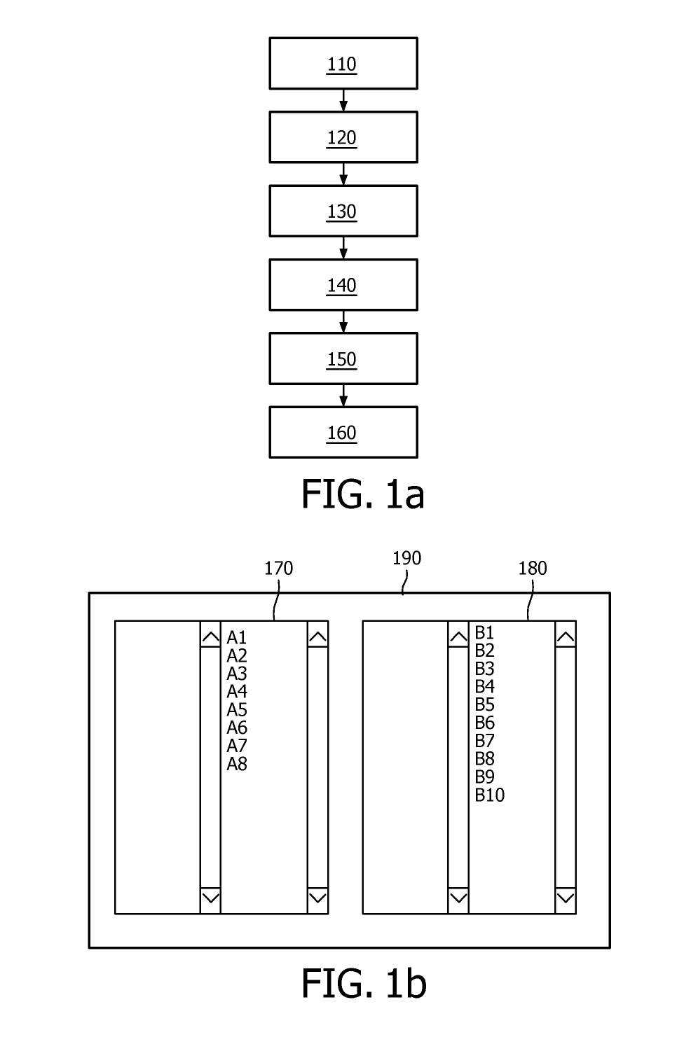

FIG. 1 (a) illustrates a schematic diagram of a flowchart of an embodiment of the method according to the present invention.

According to an embodiment of the first aspect of the present invention, a method of facilitating data entry for an information system comprising a repository is proposed. The information system is a system for providing information to users and can be implemented in many ways, such as a decision support system or a search system, etc. The repository comprises stored information to be used by the information system. Based on the repository, the information system can provide information to users.

Referring to FIG. 1 (a), in an embodiment, the method comprises a step 110 of receiving a first input from a user by means of a first user interface, the first input including at least one first category parameter of an object of interest. The user can determine the first input according to the user's experience or observation. The first user interface can be implemented in many ways; for example, the first user interface comprises a text window on a screen and the user typewrites data via a computer. The first user interface can also comprise a drop-down menu displayed on a screen, and the user can easily select parameters from the drop-down menu. The object of interest is the object which the information system is going to process. For example, the object of interest is a clinical case of interest in a clinical decision support system; or the object of interest is a legal case of interest in a legal information search system, etc.

The method further comprises a step 120 of generating a first ranked list of a plurality of second category parameters of the object of interest on the basis of the first input and the repository. The first ranked list can be generated in many ways. For example, the repository includes a plurality of occurrence probabilities consisting of the occurrence probability of each of the plurality of second category parameters upon the occurrence of each of the plurality of first category parameters. For a second category parameter, a corresponding final occurrence probability is calculated as a sum of the occurrence probability of the second category parameter upon the occurrence of each of the first inputs. Then, the first ranked list can be generated according to a descending order of a plurality of final occurrence probabilities of the plurality of second category parameters.

The method further comprises a step 130 of displaying the first ranked list to the user by means of a second user interface. The second user interface can be implemented in many ways, such as in a way comprising a text window on a screen or in a way comprising a drop-down menu displayed on a screen.

The method further comprises a step 140 of receiving a second input from the user by means of the second user interface, the second input including at least one second category parameter of the object of interest, the at least one second category parameter being selected by the user from the first ranked list. The user can determine part or all of the second input according to the ranked list, such as selecting the top three second category parameters from the first ranked list. The user can also determine part of the second input according to the user's experience or observation, such as manually inputting at least one second category parameter which is not in the first ranked list.

The method further comprises a step 150 of generating a second ranked list of a plurality of first category parameters of the object of interest on the basis of the second input and the repository. The second ranked list can be generated in many ways. For example, the repository includes a plurality of occurrence probabilities consisting of the occurrence probability of each of the plurality of first category parameters upon the occurrence of each of the plurality of second category parameters. For one first category parameter, a corresponding final occurrence probability is calculated as a sum of the occurrence probability of the first category parameter upon the occurrence of each of the second inputs. Then the second ranked list can be generated according to a descending order of a plurality of final occurrence probabilities of the plurality of first category parameters.

The method further comprises a step 160 of displaying the second ranked list to the user by means of the first user interface.

In this way, the user can get a new input list of the first category parameters by modifying the first input according to the second ranked list. If the user can find any important parameters forgotten by him in the front ranks of the second ranked list or determine any wrong input parameters, the user can get a more accurate input list so as to get a more accurate output result. In addition, all the user is required to do is make a selection, so that the whole process is easy to perform for the user.

In addition, because the user can go back and forth through different categories of parameters, the user can go back and forth through multiple partial scenarios until he is satisfied with the overall consistency of the input and output. So the user can get more information of various aspect observations at any given penultimate stage as well as the final stage.

If the information system is a clinical decision support system, the first category parameter and the second category parameter belong to different categories being respectively any one of the following parameter categories: a symptom, a test, an evaluation and a treatment. The symptom can be a high grade fever, red and swollen eyeballs or a severe body ache etc. The test can reveal a high number of leukocytes, a low blood pressure or a high blood fat etc. The evaluation's outcome can be a typhoid, a papular urticaria or a uraemia etc. The treatment can comprise quinine, aspirin or penicillin etc.

If the information system is a legal information search system, the first category parameter and the second category parameter belong to different parameter categories being respectively any one of the following parameter categories: a feature of a defendant, a fact, a provision and a judgment. A feature of a defendant can be: younger than 18 years old, a psychosis or a legal representative etc. The fact can be: illegal copy, illegal income of 5 thousand US dollars or the death of a victim etc. The provision can be: a civil law, article 10 of a criminal law or a patent law etc. The judgment can be: life imprisonment, three years in prison or a fine of one thousand US dollars.

Taking the clinical decision support system as an example, an embodiment of the method comprising step 110 to step 160 is described below.

It is assumed that a patient has a high grade fever and he wants to know more about what has happened to his body. He opens a clinical decision support system and has no idea whether he has found out all important symptoms.

Firstly, corresponding to step 110, the first category parameters are symptoms. The patient inputs two symptoms, which he has observed, into a first text window. One symptom is “a high grade fever” and another symptom is “a fever with two peaks per day”.

Secondly, corresponding to step 120, the second category parameters are evaluations. The repository comprises a plurality of symptoms and a plurality of evaluations. In addition, the repository further comprises a plurality of occurrence probabilities consisting of the occurrence probability of each of the plurality of evaluations upon the occurrence of each of the plurality of symptoms, see Table 1. For one evaluation, a corresponding final occurrence probability is calculated as a sum of the occurrence probability of the evaluation upon the occurrence of each of the symptoms input by the patient. For example, the final occurrence probability of the evaluation of “dengue” is 79% which is the sum of 43% and 36%; and the final occurrence probability of the evaluation of “malaria” is 67% which is the sum of 32% and 35%. Then “dengue” and “malaria” are listed in the front of the first ranked list of the plurality of evaluations because they have high final occurrence probabilities, and “dengue” is ranked before “malaria”.

TABLE 1

| | Evaluations | | |
|---|---|---|---|
| | dengue | malaria | . . . |
| symptoms | Probability | | |
| a fever with two peaks per day | 43% | 32% | . . . |
| a high grade fever | 36% | 35% | . . . |
| . . . | . . . | . . . | . . . |

Thirdly, corresponding to step 130, the first ranked list of the plurality of evaluations is displayed to the patient by means of a second text window. And the patient notices the evaluation of “dengue” and “malaria” because they are in the front of the first ranked list of the plurality of evaluations.

Fourthly, corresponding to step 140, the patient inputs his selection of “dengue” and “malaria” into the second text window.

Fifthly, corresponding to step 150, the repository further comprises a plurality of occurrence probabilities consisting of the occurrence probability of each of the plurality of symptoms upon the occurrence of each of the plurality of evaluations, see Table 2. For one symptom, a corresponding final occurrence probability is calculated as a sum of the occurrence probability of the symptoms upon the occurrence of each of the evaluations input by the patient. For example, the final occurrence probability of the symptom of “a high grade fever” is 200% which is the sum of 100% and 100%; the final occurrence probability of the symptom of “a fever with two peaks per day” is 97% which is the sum of 65% and 32%; the final occurrence probability of the symptom of “enlarged liver and spleen” is 100% which is the sum of 100% and 0%; and the final occurrence probability of the symptom of “red and swollen eyeballs” is 100% which is the sum of 0% and 100%. Then, in the second ranked list of the plurality of symptoms, the symptom of “a high grade fever” is listed in the top position, the symptoms of “enlarged liver and spleen” and “red and swollen eyeballs” are both listed in the second position and the symptom of “a fever with two peaks per day” is listed in the third position.

TABLE 2

| | Symptoms | | | | |
|---|---|---|---|---|---|
| | | a fever | enlarged | red and | |
| | a high | with two | liver and | swollen | |
| | grade fever | peaks per day | spleen | eyeballs | . . . |
| Evaluations | Probability | | | | |
| dengue | 100% | 65% | 0% | 100% | . . . |
| malaria | 100% | 32% | 100% | 0% | . . . |
| . . . | . . . | . . . | . . . | . . . | . . . |

Finally, corresponding to step 160, the second ranked list of the plurality of symptoms is displayed to the patient by means of the first text window. In this way, the patient can notice the symptoms of “enlarged liver and spleen” and “red and swollen eyeballs”. Then he can check whether his eyes are red and swollen and whether his liver and spleen feel good, so that he can further determine his symptoms.

It should be noted that the symptoms, probability and evaluations explained above are only for illustrating how the invention works (not a real case) and the inventor has no intention to mislead the person skilled in the art.

FIG. 1 (b) to FIG. 1 (e) illustrate a schematic diagram of an embodiment of the first user interface and the second user interface.

As shown in FIG. 1 (b) and FIG. 1 (c), the first user interface 170 and the second user interface 180 are both drop-down menus on a screen 190. Referring to FIGS. 1 (b), A1 to A8 are the first category parameters listed in the right part of the first user interface 170, and B1 to B10 are the second category parameters listed in the right part of the second user interface 180. Referring to FIG. 1 (c), the user selects A2 and A5 from the first category parameter and then the ranked list of the second category parameters in the right part of the second user interface 180 changes correspondingly. Because B6 and B3 are the top two second category parameters, referring to FIG. 1 (d), the user selects B6 and B3 and then the ranked list of the first category parameters in the right part of the first user interface 170 changes correspondingly. Based on the new ranked list of the first category parameters, the user realizes that Al fits the case for which he wants to find information and then the user adds Al to his selection of the first category parameters. Referring to FIG. 1 (e), B3 in the top of the updated ranked list is a more accurate result for the user.

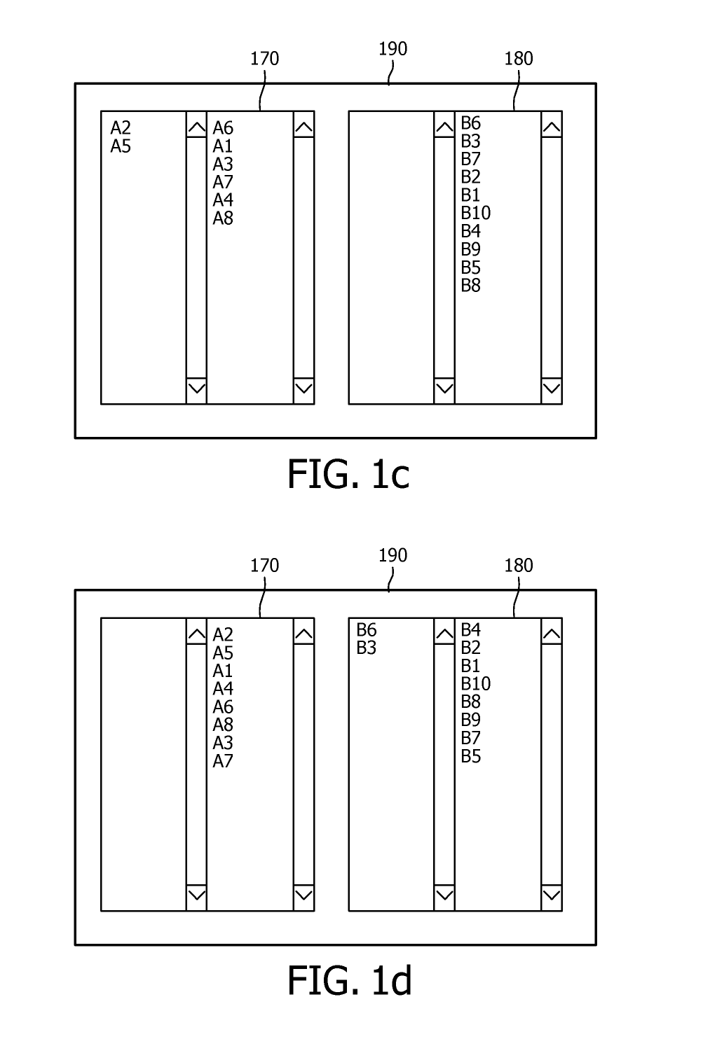

FIG. 2 illustrates a schematic diagram of a flowchart of another embodiment of the method according to the present invention.

Referring to FIG. 2, in another embodiment, the method further comprises a step 210 of generating a third ranked list of a plurality of third category parameters of the object of interest on the basis of the repository, and the first input and/or the second input. Therefore, one ranked list can be generated on the basis of one category of input or one ranked list can be generated on the basis of two categories of inputs.

The third ranked list can be generated in many ways. For example, the repository includes a plurality of occurrence probabilities consisting of the occurrence probability of each of the plurality of third category parameters upon the occurrence of each of the plurality of first category parameters and/or the plurality of second category parameters. For one third category parameter, a corresponding final occurrence probability is calculated as a sum of the occurrence probability of the third category parameter upon the occurrence of each of the first and/or second input. Then the third ranked list can be generated according to a descending order of a plurality of final occurrence probabilities of the plurality of third category parameters.

The method further comprises a step 220 of displaying the third ranked list to the user by means of a third user interface. The third user interface can be implemented in many ways, wherein it for example comprises a text window on a screen or a drop-down menu displayed on a screen.

Due to the flexible ways of getting ranked lists provided by the above embodiment, the user can get more information from the information system.

If the information system is a clinical decision support system, the first category parameter, the second category parameter and the third category parameter belong to different categories being respectively any one of the following parameter categories: a symptom, a test, an evaluation and a treatment.

If the information system is a legal information search system, the first category parameter, the second category parameter and the third category parameter belong to different parameter categories being respectively any one of the following parameter categories: a feature of a defendant, a fact, a provision and a judgment.

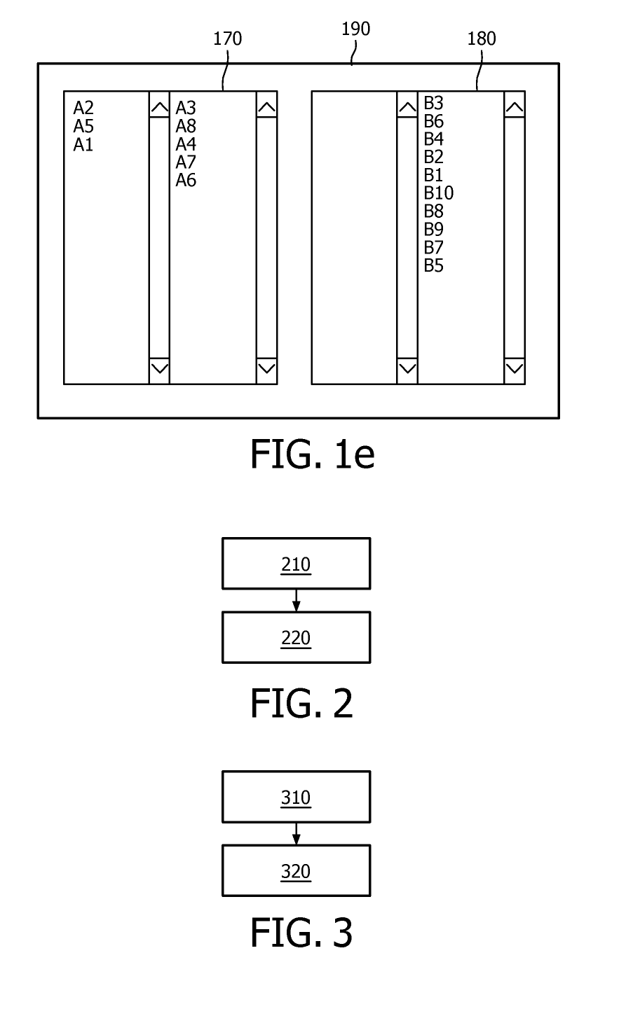

FIG. 3 illustrates a schematic diagram of a flowchart of a further embodiment of the method according to the present invention.

Referring to FIG. 3, in a further embodiment, the method further comprises a step 310 of generating a fourth ranked list of a plurality of first category parameters of the object of interest, based on the first input and the repository. The fourth ranked list can be generated in many ways. For example, the repository includes a plurality of occurrence probabilities consisting of the occurrence probability of each of the plurality of first category parameters upon the occurrence of each of the plurality of first category parameters. The occurrence probability of a first category parameter upon the occurrence of itself is 1. For one first category parameter, a corresponding final occurrence probability is calculated as a sum of the occurrence probability of the first category parameter upon the occurrence of each of the first inputs. Then the first ranked list can be generated according to a descending order of a plurality of final occurrence probabilities of the plurality of first category parameters.

The method further comprises a step 320 of displaying the fourth ranked list to the user by means of the first user interface.

In this way, the user can correct his input by having more references.

In an embodiment of the method, the repository comprises a plurality of specimens relating to a plurality of objects. The specimens can be in many types, for example, the plurality of specimens are a plurality of clinical cases if the information system is a clinical decision support system, or the plurality of specimens are a plurality of legal cases if the information system is a legal information search system.

The clinical cases may either be extracted from an existing database of real patient records by selectively including all those cases where the overall outcome of diagnosis and treatment has been satisfactory; or they may be generated through exhaustive simulation of various satisfactory courses of diagnosis and treatment as specified in a set of appropriate clinical guidelines.

When the specimens are real cases, a more convincing output result can be obtained on the basis of the specimens.

In an embodiment of step 120, step 120 comprises a sub-step of calculating a plurality of ranking factors corresponding to the plurality of secondary category parameters, each ranking factor being a weighted summation of a plurality of class-conditional probabilities of one second category parameter over the plurality of specimens, the weight of one class-conditional probability being a similarity factor of the first input and one of the plurality of specimens; and a sub-step of ranking the plurality of secondary category parameters in a descending order of the plurality of ranking factors.

Referring to equation 1, in an embodiment, φ_{C}_{ₖ} (eᵢ) is a secondary category parameter's class-conditional probability over one of the plurality of specimens and is further calculated by equation 2; and S(A, Cₖ) is a similarity factor of the first input and one of the plurality of specimens and is further calculated by equation 3.

In equations 1 to 3, R(eᵢ) is one of the plurality of ranking factors, eᵢ is one of the plurality of secondary category parameters, Cₖ is one of the plurality of specimens, and A is the first input.

$$\begin{matrix}R ( {e}_{i} ) = {\sum }_{{C}_{k}} S ( A , {C}_{k} ) \cdot {φ}_{{C}_{k}} ( {e}_{i} ) & ( 1 ) \\ {φ}_{{C}_{k}} ( {e}_{i} ) = P ( {e}_{i} \vert {C}_{k} ) & ( 2 ) \\ S ( A , {C}_{k} ) = \frac{\vert A ⋂ {C}_{k} \vert}{\vert A \vert} & ( 3 )\end{matrix}$$

Equation 3 is derived from the inclusive form of the Jaccard similarity between sets A and Cₖ , and it can be calculated as shown in equation 4 or equation 5. In equations 4 to 7, eⱼ is eₘ or eₙ ; Cₖ is one of the plurality of specimens; Ais the first input; N is the total number of the plurality of specimens; D for calculating the conditional probability in equation 7 is A or Cₖ ; the sum in equation 6 is for each specimen of the plurality of specimens; and eps is a very small positive number, such as 0.0000001, to avoid a zero occurring in the common logarithm of equation 6.

$$\begin{matrix}\begin{matrix}S ( A , {C}_{k} ) = \frac{{\sum }_{{e}_{m} ∈ A ⋂ {C}_{k}} {w}_{{e}_{m}} {φ}_{A} ( {e}_{m} ) {φ}_{{C}_{k}} ( {e}_{m} )}{{\sum }_{{e}_{n} ∈ A} {w}_{{e}_{n}} {φ}_{A}^{2} ( {e}_{m} )} \\ = \frac{{\sum }_{{e}_{m} ∈ A ⋂ {C}_{k}} {w}_{{e}_{m}} {φ}_{A} ( {e}_{m} ) {φ}_{{C}_{k}} ( {e}_{m} )}{{\sum }_{{e}_{n} ∈ A} {w}_{{e}_{n}}}\end{matrix} & ( 4 ) \\ S ( A , {C}_{k} ) = \frac{{\sum }_{{e}_{m} ∈ A ⋂ {C}_{k}} {w}_{{e}_{n }} min \{ {φ}_{A} ( {e}_{m} ) , {φ}_{{C}_{k}} ( {e}_{m} ) \}}{{\sum }_{{e}_{n} ∈ A} {w}_{{e}_{n}}} & ( 5 ) \\ {w}_{{e}_{j }} = 1 + \frac{1}{log ( N )} {\sum }_{{C}_{k}} P ( {C}_{k} \vert {e}_{j} ) log ( P ( {C}_{k} \vert {e}_{j} ) + eps ) & ( 6 ) \\ {φ}_{D} ( {e}_{j} ) = P ( {e}_{j} \vert D ) & ( 7 )\end{matrix}$$

In an embodiment of step 150, step 150 comprises a sub-step of calculating a plurality of ranking factors corresponding to the plurality of first category parameters, each ranking factor being a weighted summation of a plurality of class-conditional probabilities of one first category parameter over the plurality of specimens, the weight of one class-conditional probability being a similarity factor of the second input and one of the plurality of specimens; and a sub-step of ranking the plurality of first category parameters in a descending order of the plurality of ranking factors.

In an embodiment of step 210, step 210 comprises a sub-step of calculating a plurality of ranking factors corresponding to the plurality of third category parameters, each ranking factor being a weighted summation of a plurality of class-conditional probabilities of one third category parameter over the plurality of specimens, the weight of one class-conditional probability being a similarity factor of the first and/or second input and one of the plurality of specimens; and a sub-step of ranking the plurality of third category parameters in a descending order of the plurality of ranking factors.

In an embodiment of step 310, step 310 comprises a sub-step of calculating a plurality of ranking factors corresponding to the plurality of first category parameters, each ranking factor being a weighted summation of a plurality of class-conditional probabilities of one first category parameter over the plurality of specimens, the weight of one class-conditional probability being a similarity factor of the first input and one of the plurality of specimens; and a sub-step of ranking the plurality of first category parameters in a descending order of the plurality of ranking factors.

In the above embodiments of steps 150, 210 and 310, the calculation of the plurality of ranking factors can also be performed using equations 1 to 7 by replacing the variables in equations 1 to 7 correspondingly. For example, for the embodiment of the step 150, the first input is replaced by the second input and the second category of parameters is replaced by the first category of parameters.

In an embodiment of the method, the method further comprises a step of clustering the plurality of specimens into a plurality of clusters according to a preset threshold and a plurality of similarity factors, each similarity factor corresponding respectively to every two specimens among the plurality of specimens.

The similarity factor of two specimens among the plurality of specimens can be calculated as equation 8 or equation 9. In equations 8 to 11, eⱼ is eₖ or eₗ , Cₖ is one of the plurality of specimens; A and B are two specimens among the plurality of specimens; N is the total number of the plurality of specimens; D for calculating the conditional probability in equation 10 is A or B; the sum in equation 10 is for each specimen of the plurality of specimens; and eps is a very small positive number, such as 0.0000001, to avoid a zero occurring in the common logarithm of equation 10.

$$\begin{matrix}S ( A , B ) = \frac{{\sum }_{{e}_{k} ∈ A ⋃ B} {w}_{{e}_{k}} {φ}_{A} ( {e}_{k} ) {φ}_{B} ( {e}_{k} )}{{\sum }_{{e}_{1} ∈ A ⋃ B} {w}_{{e}_{1}} \{ {φ}_{A}^{2} ( {e}_{1} ) + {φ}_{B}^{2} ( {e}_{1} ) - {φ}_{A} ( {e}_{1} ) {φ}_{B} ( {e}_{1} ) \}} & ( 8 ) \\ S ( A , B ) = \frac{{\sum }_{{e}_{k} ∈ A ⋃ B} {w}_{{e}_{k}} min \{ {φ}_{A} ( {e}_{k} ) , {φ}_{B} ( {e}_{k} ) \}}{{\sum }_{{e}_{1} ∈ A ⋃ B} {w}_{{e}_{1}} max \{ {φ}_{A} ( {e}_{1} ) , {φ}_{B} ( {e}_{1} ) \}} & ( 9 ) \\ {w}_{{e}_{j}} = 1 + \frac{1}{log ( N )} {\sum }_{{C}_{k}} P ( {C}_{k} \vert {e}_{j} ) log ( P ( {C}_{k} \vert {e}_{j} ) + eps ) & ( 10 ) \\ {φ}_{D} ( {e}_{j} ) = P ( {e}_{j} \vert D ) & ( 11 )\end{matrix}$$

By comparing each of the plurality of similarity factors with the preset threshold, it can be determined whether every two specimens belong to one cluster. For example, if a similarity factor between two specimens is higher than the preset threshold, the two specimens belong to one cluster; otherwise, they belong to two different clusters.

After clustering the plurality of specimens into a plurality of clusters, the ranking factors calculated by equations 1 to 7 can be calculated on the basis of the plurality of clusters instead of on the basis of the plurality of specimens. In this scenario, equation 2 and equation 7 are not calculated in real-time; instead they are calculated beforehand and then stored in the information system; Cₖ is one of the plurality of clusters; N is the total number of clusters and the meaning of the other variables is unchanged. Because the number of clusters is lower than the number of specimens, the ranking factors can be generated in less time.

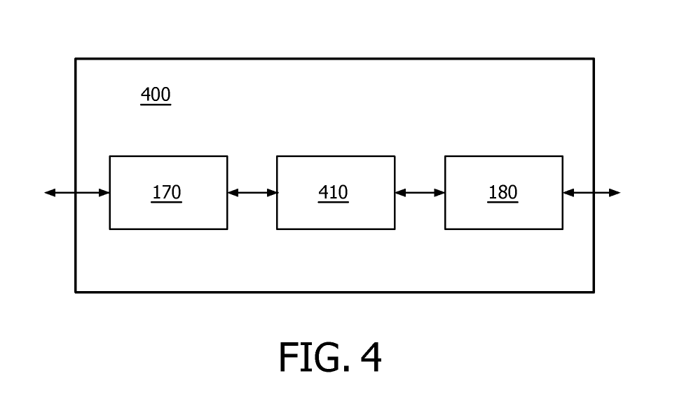

FIG. 4 illustrates a schematic diagram of an embodiment of the system according to the invention.

According to an embodiment of a second aspect of the present invention, a system 400 for facilitating data entry for an information system comprising a repository is proposed.

Referring to FIG. 4, the system 400 comprises a first user interface 170 configured to receive a first input from a user, the first input including at least one first category parameter of an object of interest.

The system 400 further comprises a processor 410 configured to generate a first ranked list of a plurality of second category parameters of the object of interest on the basis of the first input and the repository.

The system 400 further comprises a second user interface 180 configured to display the first ranked list to the user.

The second user interface 180 is further configured to receive a second input from the user, the second input including at least one second category parameter of the object of interest, the at least one second category parameter being selected by the user from the first ranked list.

The processor 410 is further configured to generate a second ranked list of a plurality of first category parameters of the object of interest on the basis of the second input and the repository.

The first user interface 170 is further configured to display the second ranked list to the user.

If the information system is a clinical decision support system, the first category parameter and the second category parameter belong to different categories being respectively any one of the following parameter categories: a symptom, a test, an evaluation and a treatment.

If the information system is a legal information search system, the first category parameter and the second category parameter belong to different parameter categories being respectively any one of the following parameter categories: a feature of a defendant, a fact, a provision and a judgment.

In another embodiment of the system 400, the processor 410 is further configured to generate a third ranked list of a plurality of third category parameters of the object of interest based on the repository, and the first input and/or the second input; and the system further comprises a third user interface (not shown) configured to display the third ranked list to the user.

If the information system is a clinical decision support system, the first category parameter, the second category parameter and the third category parameter belong to different categories being respectively any one of the following parameter categories: a symptom, a test, an evaluation and a treatment.

If the information system is a legal information search system, the first category parameter, the second category parameter and the third category parameter belong to different parameter categories being respectively any one of the following parameter categories: a feature of a defendant, a fact, a provision and a judgment.

In a further embodiment of the system, the processor 410 is further configured to generate a fourth ranked list of a plurality of first category parameters of the object of interest, based on the first input and the repository; and the first user interface 170 is further configured to display the fourth ranked list to the user.

In the above embodiments of the system, the repository comprises a plurality of specimens relating to a plurality of objects. The specimens can be in many types, for example, the plurality of specimens are a plurality of clinical cases if the information system is a clinical decision support system, or the plurality of specimens are a plurality of legal cases if the information system is a legal information search system.

In an embodiment of the processor 410, when the processor 410 is configured to generate the first ranked list of the plurality of second category parameters, the processor 410 is adapted to calculate a plurality of ranking factors corresponding to the plurality of secondary category parameters, each ranking factor being a weighted summation of a plurality of class-conditional probabilities of one second category parameter over the plurality of specimens, the weight of one class-conditional probability being a similarity factor of the first input and one of the plurality of specimens; and to rank the plurality of secondary category parameters in a descending order of the plurality of ranking factors.

In another embodiment of the processor 410, when the processor 410 is configured to generate the second ranked list of the plurality of first category parameters, the processor 410 is adapted to calculate a plurality of ranking factors corresponding to the plurality of first category parameters, each ranking factor being a weighted summation of a plurality of class-conditional probabilities of one first category parameter over the plurality of specimens, the weight of one class-conditional probability being a similarity factor of the second input and one of the plurality of specimens; and to rank the plurality of first category parameters in a descending order of the plurality of ranking factors.

In a further embodiment of the processor 410, when the processor 410 is configured to generate the third ranked list of the plurality of third category parameters, the processor 410 is adapted to calculate a plurality of ranking factors corresponding to the plurality of third category parameters, each ranking factor being a weighted summation of a plurality of class-conditional probabilities of one third category parameter over the plurality of specimens, the weight of one class-conditional probability being a similarity factor of the first and/or second input and one of the plurality of specimens; and to rank the plurality of third category parameters in a descending order of the plurality of ranking factors.

In yet another embodiment of the processor 410, when the processor 410 is configured to generate the fourth ranked list of the plurality of first category parameters, the processor 410 is adapted to calculate a plurality of ranking factors corresponding to the plurality of first category parameters, each ranking factor being a weighted summation of a plurality of class-conditional probabilities of one fourth category parameter over the plurality of specimens, the weight of one class-conditional probability being a similarity factor of the first input and one of the plurality of specimens; and to rank the plurality of first category parameters in a descending order of the plurality of ranking factors.

In an embodiment of the system, the processor 410 is further configured to cluster the plurality of specimens into a plurality of clusters, based on a preset threshold and a plurality of similarity factors, each similarity factor corresponding respectively to every two specimens among the plurality of specimens.

The present invention relates to a method of facilitating data entry for an information system comprising a repository. Although some clinical information system-related examples are used for illustrative purpose, the inventor has no intention to provide any diagnostic methods. Furthermore, the purpose of the present invention is not to obtain the diagnostic result of a disease or health condition, but to provide a method for data input to improve the users' experience when they are using the information system, such as helping the user to determine the input for the information system or helping the user to understand the relationship between different categories of parameters which are output by the information system.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the system claims enumerating several units, several of these units can be embodied by one and the same item of hardware or software. The usage of the words first, second and third, et cetera, does not indicate any ordering. These words are to be interpreted as names.

1. A method of facilitating data entry for an information system comprising a repository, the method comprising the steps of:
receiving (110) a first input from a user by means of a first user interface (170), the first input including at least one first category parameter of an object of interest;
generating (120) a first ranked list of a plurality of second category parameters of the object of interest on the basis of the first input and the repository;
displaying (130) the first ranked list to the user by means of a second user interface (180);
receiving (140) a second input from the user by means of the second user interface (180), the second input including at least one second category parameter of the object of interest, the an least one second category parameter being selected by the user from the first ranked list;
generating (150) a second ranked list of a plurality of first category parameters of the object of interest on the basis of the second input and the repository; and
displaying (160) the second ranked list to the user by means of the first user interface (170).

2. A method as claimed in claim 1, further comprising the steps of:
generating (210) a third ranked list of a plurality of third category parameters of the object of interest on the basis of the repository, and the first and/or the second input; and
displaying (220) the third ranked list to the user by means of a third user interface.

3. A method as claimed in claim 1, further comprising the steps of:
generating (310) a fourth ranked list of a plurality of first category parameters of the object of interest, based on the first input and the repository; and
displaying (320) the fourth ranked list to the user by means of the first user interface (170).

4. A method as claimed in claim 2, wherein the information system is a clinical decision support system, and the first category parameter, the second category parameter and the third category parameter belong to different categories being any one of the following parameter categories: a symptom, a test, an evaluation and a treatment.

5. A method as claimed in claim 2, wherein the information system is a legal information search system, and the first category parameter, the second category parameter and the third parameter belong to different parameter categories being respectively any one of the following parameter categories: a feature of a defendant, a fact, a provision and a judgment.

6. A method as claimed in claim 1, wherein the repository comprises, a plurality of specimens relating to a plurality of objects.

7. A method as claimed in claim 6, wherein the information system is a clinical decision support system and the plurality of specimens are a plurality of clinical cases, or the information system is a legal information search system and the plurality of specimens are a plurality of legal cases.

8. A method as claimed in claim 6, further comprising a step performed before the step of generating (120) the first ranked list, said step being:
clustering the plurality of specimens into a plurality of clusters, based on a preset threshold and a plurality of similarity factors, each similarity factor corresponding respectively to every two specimens among the plurality of specimens.

9. A method as claimed in claim 6, wherein each step of generating (120, 150, 210, 310) comprises the sub-steps of:
calculating a plurality of ranking factors corresponding to a plurality of parameters to be ranked, each ranking factor being a weighted summation of a plurality of class-conditional probabilities of one parameter to be ranked over the plurality of specimens respectively, the weight of one class-conditional probability being a similarity factor of an input and one of the plurality of specimens; and
ranking the plurality of parameters to be ranked, in a descending order of the plurality of ranking factors,
wherein corresponding to respectively each step of generating (120, 150, 210, 310), the plurality of parameters to be ranked and the input are, respectively:
the plurality of secondary category parameters and the first input for the step of generating (120) the first ranked list;
the plurality of first category parameters and the second input for the step of generating (150) the second ranked list;
the plurality of third category parameters and the first and/or the second input for the step of generating (210) the third ranked list; and
the plurality of first category parameters and the first input for the step of generating (310) the fourth ranked list.

10. A system for facilitating data entry for an information system having a repository, comprising:
a first user interface (170) configured to receive a first input from a user, the first input including at least one first category parameter of an object of interest;
a processor (410) configured to generate a first ranked list of a plurality of second category parameters of the object of interest on the basis of the first input and the repository; and a second user interface (180) configured to display the first ranked list to the user;
wherein
the second user interface (170) is further configured to receive a second input from the user, the second input including at least one second category parameter of the object of interest, the at least one second category parameter being selected by the user from the first ranked list;
the processor (410) is further configured to generate a second. ranked list of a plurality of first category parameters of the object of interest on the basis of the second input and the repository; and
the first user interface (180) is further configured. to display the second ranked list to the user.

11. A system as claimed in claim 10, wherein the processor (410) is further configured to generate a third ranked list of a plurality of third category parameters of the object of interest, based on the repository and the first input and/or the second input; and
the system further comprises a third user interface configured to display the third ranked list to the user.

12. A system as claimed in claim 10, wherein the processor (410) is further configured to generate a fourth ranked list of a plurality of first category parameters of the object of interest, based on the first input and the repository; and the first user interface (170) is further configured to display the fourth ranked list to the user.

13. A system as claimed in claim 11, wherein the information system is a clinical decision support system, and the first category parameter, the second category parameter and the third category parameter belong to different categories being respectively any one of the following parameter categories: a symptom, a test, an evaluation and a treatment.

14. A system as claimed in claim 10, wherein the repository comprises a plurality of specimens.

15. A system as claimed in claim 14, wherein the processor (410) is further configured to cluster the plurality of specimens into a plurality of clusters, based on a preset threshold and a plurality of similarity factors, each similarity factor corresponding respectively to every two specimens among the plurality of specimens.
